(19) United States
(12) Patent Application Publication
(10) Pub. No.: US 2023/0035553 A1
(43) Pub. Date: Feb. 2, 2023

(54) CUSTOMIZED VIDEO PRESENTATIONS METHODS AND SYSTEMS

(71) Applicant: General Galactic Corporation, Chicago, IL (US)

(72) Inventors: Jordan Ho, Chicago, IL (US); Gauri Sharma, Chicago, IL (US); Dylan Richard, Evanston, IL (US); Harper Reed, Chicago, IL (US); Ivan Indrautama, Chicago, IL (US)

(21) Appl. No.: 17/876,252

(22) Filed: Jul. 28, 2022

Related U.S. Application Data
(60) Provisional application No. 63/226,478, filed on Jul. 28, 2021.

(51) Int. Cl. G06T 11/60

(52) U.S. Cl. CPC G06T 11/60; G06T 2200/24

(57) ABSTRACT

Systems and methods for video collaboration enhancement are presented. An example system can include one or more computer processors programmed to perform one or more operations. In some examples, the one or more operations can include initiating a virtual camera, where the virtual camera can be configured to output an augmented video feed, the augmented video feed including one or more virtual overlay effects. In some examples, the one or more operations can include combining one or more virtual overlay effects with a video feed received from a physical camera to form the augmented video feed, where the one or more virtual overlay effects are displayed in conjunction with the video feed received from a physical camera. In some examples, the one or more operations can include displaying the augmented video feed on a display device.

### CROSS-REFERENCE TO RELATED APPLICATIONS

This application claims priority to and the benefit of U.S. Provisional Application No. 63/226,478 titled “Customized Video Presentation Methods and Systems” and filed Jul. 28, 2021, which is incorporated herein by reference in its entirety.

### TECHNICAL FIELD

The present invention generally relates to the field of distributed collaboration software platforms, and more specifically, to methods and supporting systems for enhancing existing user interfaces such that individuals can manage various visual aspects of their representation within a remote, collaborative video platform.

### BACKGROUND

Corporations, project teams, and even friends and family members have long recognized the need and benefit of remote video communications. At the outset, the hardware and software platforms necessary to effectively take advantage of remote video collaboration was expensive, and typically limited to corporate environments. However with the ubiquitous nature of high-bandwidth internet access and a plethora of web-based collaboration applications, small teams can now leverage remote video collaboration to the same extent as multi-billion dollar corporations.

More recently, as world events have forced entire organizations to “go virtual” the use of remote video collaboration platforms such as Microsoft Teams, Zoom, WebEx, Google Hangouts, and others have exploded. And while some of these applications include features that allow users to customize certain aspects of their appearance (e.g., virtual backgrounds) users' desire to incorporate their own personality and “fun” into what can otherwise be laborious meetings has also grown dramatically. Additionally, the demand for customizable visual productivity and communication tools while in these platforms has risen. Therefore, there is a need for methods and supporting systems that facilitate the customization of users' video feeds while participating in virtual meetings and anywhere users' video feeds will be displayed.

As new mediums for communication and collaboration emerge and are adopted (e.g, augmented reality glasses, metaverse digital representations, and other video surfaces you can “see through”) the need and desire for people to customize and enhance them will increase as well.

The foregoing discussion, including the description of motivations for some embodiments of the invention, is intended to assist the reader in understanding the present disclosure, is not admitted to be prior art, and does not in any way limit the scope of any of the claims.

### SUMMARY

In various examples, the subject matter of this disclosure relates to devices, systems, and methods for enhancing distributed collaboration software platforms. In one aspect, the system can include one or more computer processors programmed to perform one or more operations. In some examples, the one or more operations can include initiating a virtual camera, where the virtual camera can be configured to output an augmented video feed, the augmented video feed including one or more virtual overlay effects. In some examples, the one or more operations can include combining one or more virtual overlay effects with a video feed received from a physical camera to form the augmented video feed, where the one or more virtual overlay effects are displayed in conjunction with the video feed received from a physical camera. In some examples, the one or more operations can include displaying the augmented video feed on a display device.

Various embodiments of the system can include one or more of the following features.

In some examples, the one or more virtual overlay effects can include a static virtual overlay. In some implementations, the one or more virtual overlay effects can include a dynamic virtual overlay. In some embodiments, the video feed received from a physical camera is a live video feed (e.g., the virtual overlay is displayed in real time over the live video feed), whereas in other instances the virtual overlay is combined with a stored video feed from the physical camera such that the two feeds are asynchronous. In some instances, the one or more virtual overlay effects can include a text overlay application. In some examples, the text overlay application can be configured to allow a user to select at least one of a user selected font, a user selected font size, or a user selected font color. In some implementations, the one or more virtual overlay effects can include a user identification application. In some instances, the user identification application can be configured to allow a user to select at least one of a user name, or a user identification. In some instances, the one or more virtual overlay effects can include a weather application. In some examples, the weather application can be configured to display at least one of weather information at a location of a user, or weather information of a user selected location. In some implementations, the one or more virtual overlay effects can include at least one of data updated in real time, or data updated in a user selected frequency. In some instances, the one or more virtual overlay effects can include an image. In some examples, the image can include an emoji. In some instances, the image can include a QR code. In some implementations, the QR code can include a link to a website with an exclusive purchase offer, a video game, or a collaboration platform. In some instances, the virtual overlay can include at least one of a time application, a stock application, a shopping application or a game application.

Also described herein is a computer-implemented method for enhancing distributed collaboration software platforms. In some examples, the method can include initiating a virtual camera, where the virtual camera can be configured to output an augmented video feed, the augmented video feed comprising one or more virtual overlay effects. In some examples, the method can include combining one or more virtual overlay effects with a video feed received from a physical camera to form the augmented video feed, where the one or more virtual overlay effects can be displayed in conjunction with the video feed received from a physical camera. In some examples, the method can include displaying the augmented video feed on a display device.

Further described herein is a non-transitory computer-readable medium having instructions stored thereon that, when executed by one or more computer processors, cause the one or more computer processors to perform one or more operations. In some examples, the one or more operations can include initiating a virtual camera, where the virtual camera can be configured to output an augmented video feed, the augmented video feed including one or more virtual overlay effects. In some examples, the one or more operations can include combining one or more virtual overlay effects with a video feed received from a physical camera to form the augmented video feed, where the one or more virtual overlay effects can be displayed in conjunction with the video feed received from a physical camera. In some examples, the one or more operations can include displaying the augmented video feed on a display device.

The above and other preferred features, including various novel details of implementation and combination of events, will now be more particularly described with reference to the accompanying figures and pointed out in the claims. It will be understood that the particular systems and methods described herein are shown by way of illustration only and not as limitations. As will be understood by those skilled in the art, the principles and features described herein may be employed in various and numerous embodiments without departing from the scope of any of the present inventions. As can be appreciated from foregoing and following description, each and every feature described herein, and each and every combination of two or more such features, is included within the scope of the present disclosure provided that the features included in such a combination are not mutually inconsistent. In addition, any feature or combination of features may be specifically excluded from any embodiment of any of the present inventions.

### BRIEF DESCRIPTION OF THE DRAWINGS

The accompanying figures, which are included as part of the present specification, illustrate the presently preferred embodiments and together with the general description given above and the detailed description of the preferred embodiments given below serve to explain and teach the principles described herein.

FIG. 1 illustrates an overview of the various components of a video collaboration enhancement platform, according to some embodiments.

FIGS. 2A-2D illustrate various stages of a user interface of the video collaboration enhancement platform, according to some embodiments.

FIG. 3 illustrates an exemplary video screen including various enhancements configured by a user of the video collaboration enhancement platform, according to some embodiments.

FIG. 4 illustrates a collection of applications within an application marketplace of the video collaboration enhancement platform, according to some embodiments.

FIG. 5 illustrates a collection of applications available within a user's profile of the video collaboration enhancement platform, according to some embodiments.

FIG. 6 illustrates various customizations available to a user within specific applications operating within the video collaboration enhancement platform, according to some embodiments.

FIG. 7 illustrates an exemplary customization option within an application on the video collaboration enhancement platform, according to some embodiments.

FIGS. 8A and 8B illustrate exemplary group invitation and interaction screens to facilitate multi-party interactions within the video collaboration enhancement platform, according to some embodiments.

FIG. 9 illustrates a developer profile screen within a developer environment of the video collaboration enhancement platform, according to some embodiments.

FIG. 10 illustrates an application profile screen for the video collaboration enhancement platform, according to some embodiments.

FIG. 11 illustrates a schematic diagram of an exemplary hardware and software system implementing the systems and methods described herein, according to some embodiments.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

Systems and methods for enhancing distributed collaboration software platforms are presented, in some embodiments.

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details.

### Overview of a Video Collaboration and Enhancement Platform

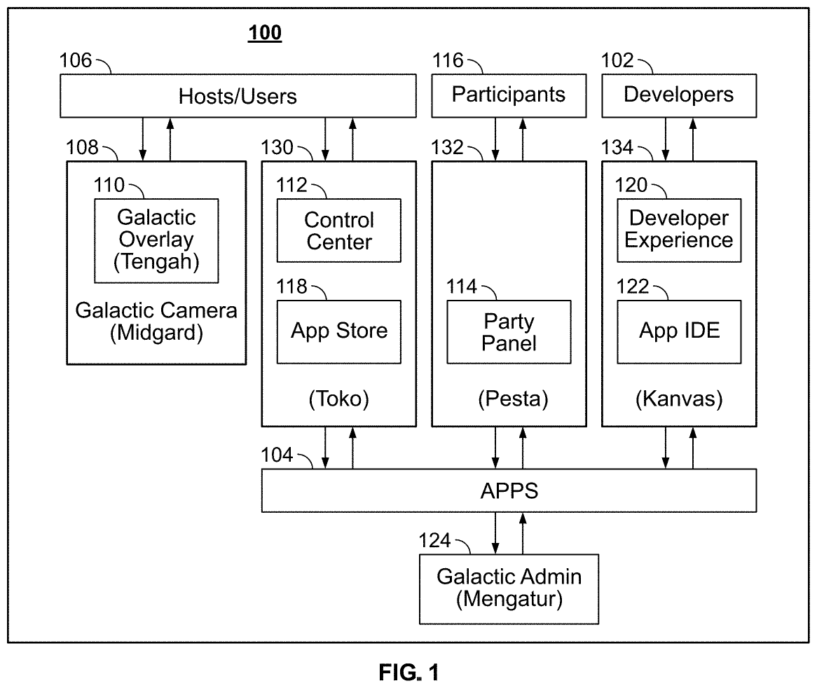

FIG. 1 illustrates an overview of the various components of a video collaboration enhancement platform, according to some embodiments. In some embodiments, the video collaboration enhancement platform 100 can be configured to allow developers 102 to build and/or publish applications 104 for use within the platform 100. In some examples, the applications 102, e.g., be it published and/or unpublished, can allow users 106 to enhance their displayed video, presentation and/or other video based features of the video collaboration enhancement platform 100. The platform 100, in some embodiments, can provide a virtual camera 108 to automatically combine and/or composite a unique website and/or overlay effect 110 for a user on top of the user's video feed. In some embodiments, as used herein, the overlay effect 110 can be referred to as a virtual overlay effect, among other terms. To facilitate the collaborative aspects of the platform 100, in some embodiments, the platform 100 can include a control center 112 in which users can host virtual events and/or online meetings using a collaboration panel, e.g., can be referred to herein as a “party panel” 114. In some embodiments, the party panel 114 can be configured to allow participants 116, e.g., of a virtual event and/or online meeting, to interact with one another via one or more virtual overlays effects 110. In some instances, the one or more virtual overlay effects 110 and/or features can be implemented using applications 104 that are made available in an application store 118. In some instances, the one or more virtual overlay effects 110 and/or features can be developed on a developer platform 120, which can be provided to the user community. In some embodiments, the video collaboration enhancement platform 100 can be referred to herein as a platform, e.g., or the “platform”.

Referring again to FIG. 1, in some embodiments, components of the video collaboration enhancement platform 100 can include a virtual camera 108. In some instances, the virtual camera 108 can be implemented as a software plugin to a user's operating environment. In an example, users 106 operating a video collaboration application can typically be asked to select a “camera” for the application to use as its source of video, e.g., as a source for its video feed. A user 106, in some examples, can select a camera from a list of physical devices either embedded in the user's computer, tablet, computing device and/or phone. In addition to selecting a camera from a list of physical devices, in some embodiments, a “virtual” camera 108 can be added to the options available to a user 106. In some examples, the user 106, presented with the option of using the virtual camera 108 or physical camera, can instead select the virtual camera 108 as an input device for the video collaboration application. Upon selecting the virtual camera 108 , in some implementations, the virtual camera 108 can execute software in the background to combine and/or composite the video feed from the physical camera with one or more virtual overlay effects 110 . In some embodiments, the virtual camera 108 can combine the video feed from the physical camera, e.g., in some instances a default camera video feed, with virtual overlay effects 110 and/or enhancements selected by the user 106 and generated by one or more virtual overlay effect applications 104 that are then presented to the user's video collaboration application. In some embodiments, as used herein, virtual overlay effect application 104 can be referred to as a virtual overlay application, overlay application, and/or an application, among other examples. In some embodiments, the virtual camera 108 can be part of, and/or included in a downloadable client application.

Referring again to FIG. 1, in some embodiments, the video collaboration enhancement platform 100 can include an augmented video feed. In some embodiments, the one or more virtual overlay effects 110 can be combined with the video feed captured from the user's physical camera to form the augmented video feed. In some examples, the augmented video feed can include a customized display, overlay and/or combined virtual video feed for presentation to the other participants 116 in a virtual collaboration meeting and/or call. In some implementations, each individual user 106 of the video collaboration enhancement platform 100 can have their own virtual overlay effect which can be presented as transparent, web-based objects from virtual overlay effect applications installed by a user 106 and as a layer above the user's actual video feed and into a live video stream, e.g., referred to herein as the augmented video feed. In some instances, the virtual overlay effects 110 can be reactive via machine learning, triggered by user actions, take input from external data sources, and/or individually turned on or off. In some implementations, the virtual overlay effect 110 can be static, e.g., can maintain the same location on the augmented video feed, remain as the same image throughout the augmented video feed, among other examples.

Referring again to FIG. 1, in some implementations, the video collaboration enhancement platform can 100 include a control center 112 and/or an application store 118. The control center 112, in some examples, can be configured to allow users 106 to manage, customize and/or control their individual augmented video feed and/or display. In some implementations, the control center 112 can be configured to allow users 106 to manage, customize and/or control one or more applications 104 installed onto their device(s). In some instances, the control center 112 can be configured to allow users 106 to manage, customize and/or control one or more user accounts and/or user profile information. In one example, the control center 112 can include a web-based application configured to be accessed via a standard browser and/or on a mobile device. The control center 112 can include, in some examples, a display bar configured to allow one or more users 106 to display a status (e.g., logged in, active, etc.). In some implementations, the control center 112 can include a display bar configured to allow one or more users 106 to manage applications installed in the video collaboration enhancement platform 100. The control center 112 can include, in some instances, a display bar configured to allow one or more users 106 to select a desired aspect ratio for their display. In some examples, the control center 112 can include a display bar configured to control the operation of applications 104, e.g., turn on the application 104, turn off the application 104, and/or select actions within one or more applications 104. In some implementations, the control center 112 can include a display bar configured allow a user 106 to manage the user's profile (e.g., name, nickname, picture, etc.) within the video collaboration enhancement platform 100 and/or within the one or more applications 104 of the video collaboration enhancement platform 100. In some embodiments, the control center 112 and the application store 118 can collectively be referred to herein as a control software 130.

Referring again to FIG. 1, in some embodiments, as described above, the video collaboration enhancement platform 100 can include an application store 118. The application store 118, in some examples, can be configured to list and/or provide information about the one or more virtual overlay effect applications 104 of the video collaboration enhancement platform 100. In some instances, the applications can be built by users 106 and/or community members. In some examples, a community member can include users not otherwise affiliated with an entity providing the video collaboration enhancement platform. In some implementations, the application store 118 can include a preview and/or screen shot corresponding to a specific virtual overlay effect application 104. In some examples, the screenshot can enable users 106 to see what the virtual overlay effect application 104 will look like when added to that user's augmented video feed, presentation and/or display. The application store 118, in some instances, can include metadata about one or more virtual overlay effect applications. In some examples, the metadata can include who the application 104 was developed by, when the application 104 was developed, one or more descriptive tags about the application, among other examples. In some instances, the application store 118 can be configured to allow users 106 to search for applications 104 based on various characteristics, metadata tags. In some examples, a search bar, search mechanism, and/or other search implementation which can allow for users 106 to search for applications 104 in the video collaboration enhancement platform 100.

Referring again to FIG. 1, the one or more virtual overlay effect applications 104, in some embodiments, can include individual applications 104 that can be added by users 106 to customize their augmented video feed, video presentation stream and/or video display. The applications 104 can, in some instances, provide various visual effects. In some examples, the visual effects can include, but are not limited to: floating text, static images, emojis, animated images (GIFs), videos, real-time graphics, interactive results of polls, and/or one or more visual effects that can be created on the open web. In some implementations, the applications 104 can be static, e.g., include a static application. In some examples, the static application can include an application 104 that maintains its location throughout an entire augmented video feed. In one example, a static application can include an application that uses the same image throughout the augmented video feed. In some implementations, the application 104 can be dynamic, e.g., include a dynamic application. In some examples, a dynamic application can include an interactive application. A dynamic application, in some examples, can allow both a presenter and/or a viewer to interact with visual elements and/or overlay effects 110 within the augmented video feed. In an exemplary application, the application 104 can allow a participant 116, e.g., a user, to answer a poll question on a collaboration panel and/or party panel 114. In the same exemplary application 104, that user's answer can be displayed in real-time on another user's display, e.g., on a presenter's display, and in some instances shown to each display of every participant 116. In some implementations, each application 104 can include a preview screen, metadata and/or interface schemas. The preview screen, metadata and/or interface schemas can, in some instances, include various settings and/or actions available within the application. In some examples, the preview screen can show a countdown timer. In the same example, the meta data associated with the countdown timer can explain what kind of timer it is, and/or how the countdown timer works. In some embodiments, the one or more applications 104 can include a settings menu which can, in some examples, allow a user 106 to set the duration of the timer, and/or the actions that would allow the user 106 to start, pause, stop, and reset the timer. In some implementations, the applications 104 themselves can be coded and/or developed using a combination of javascript, HTML, and/or CSS, among other programming languages. In some instances, programming templates, e.g., referred to as starter templates, can be provided to allow users 106 and/or a user community to develop custom virtual overlay effect applications 104.

Referring again to FIG. 1, in some embodiments, the collaboration panel 114 can be used by participants in a video collaboration event to interact with overlays effects 110 included in the presenter's augmented video feed. The interaction, in some instances, can be based on the applications 104 and/or application settings installed and/or selected by the presenter. In some embodiments, the collaboration panel 114 can be presented as a web-based interface, e.g., no separate application is necessary. In some embodiments, no account creation and/or software installation is needed. In some examples, anyone receiving an invitation to the collaboration panel 114 can participate through their existing web browser. In one instance, an individual user and/or collaboration panel host can use a unique code (e.g., alphanumeric string, QR code, or other machine readable code) that can direct participants to one or more hosted events. In some implementations, a different participant 116 can be assigned specific party actions by the host. In one example, participants who are logged in might have the ability to perform some functions, while other participants can have the ability to perform other functions. In some examples, some users 106 and/or participants 116 can perform functions including asking questions, while other users 106 and/or participants 116 that are not logged in may only be able to react with emojis. In some embodiments, the collaboration panel and/or party panel 114 along with any other collaboration functions used herein can collectively be referred to herein as collaboration software 132.

Referring to FIG. 1, in some embodiments, the video collaboration enhancement platform 100 can include a developer platform 120. In some examples, the video collaboration enhancement can include an integrated development environment (IDE) 122. The developer platform can 120, in some instances, be used by both the video collaboration enhancement platform provider and/or members of the community using the video collaboration enhancement platform to create, update, preview, version, and/or manage the applications in the application store 118. In some embodiments, the developer platform 120 can be configured to use existing open web standards. In some examples, the developer platform 120 can be configured to allow community developers to create one or more visual overlay effects 110 without having to learn motion graphics products and/or learn other more complex programming languages or tools. In some embodiments, the software platform 120 and the IDE 122 can collectively be referred to herein as a developer software 134. As shown in FIG. 1, the one or more applications 104 can be across all of the control software 130, collaboration software 132 and the developer software 134, where each application 104 can be created, managed and used. An administrator 124, can also have access to, manage, create and use the applications 104. In some examples, the administrator 104 can manage security, privacy and/or overall access to the applications 104.

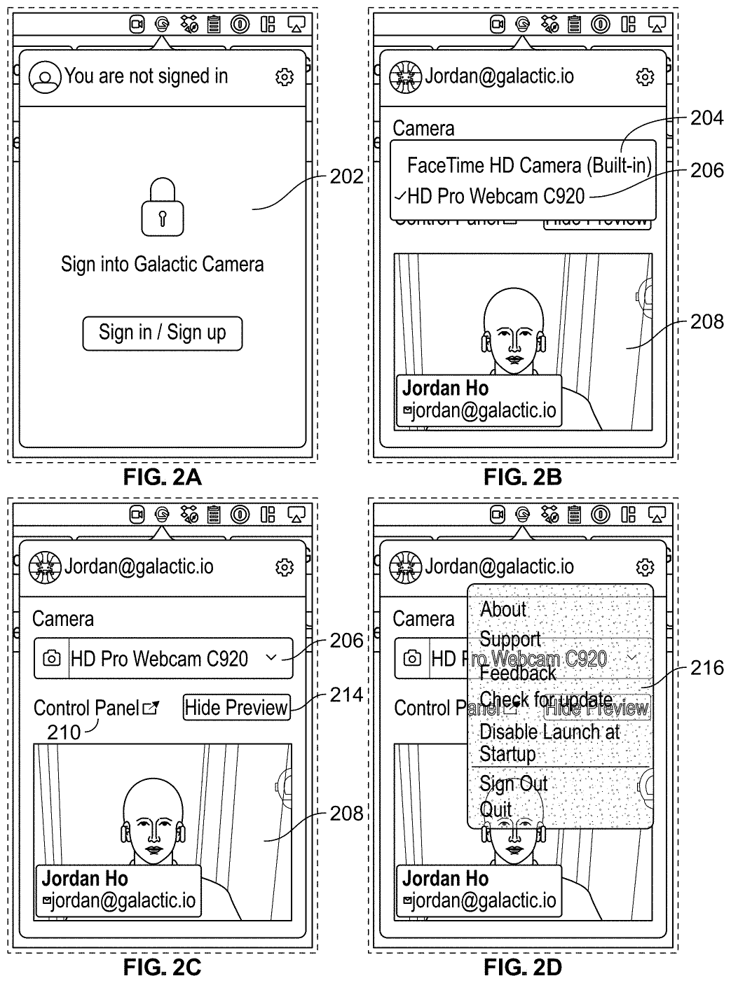

FIGS. 2A-2D illustrate steps for initiating a virtual camera, according to some embodiments. In some embodiments, referring to FIG. 2A, upon launching the platform, a user is presented a registration/login screen 202 which can be used to capture and authenticate user credentials. FIGS. 2B and 2C, according to some embodiments, illustrate presenting the user with available camera options 204, 206. In some embodiments, FIGS. 2B and 2C illustrate a current video stream preview 208. At FIG. 2C, the user selects the video source 206 for the platform to use as its video feed (e.g., the HD Pro Webcam C920). FIG. 2C illustrates an example where the user is signed in 210. Furthermore, FIG. 2C illustrates that the user has access to the control panel 212 and can disable and/or hide the video feed preview 214. FIG. 2D. illustrates an exemplary virtual camera menu 216 providing options that allow the user to provide feedback, update the virtual camera software, and/or exit the initiation screen, among other options.

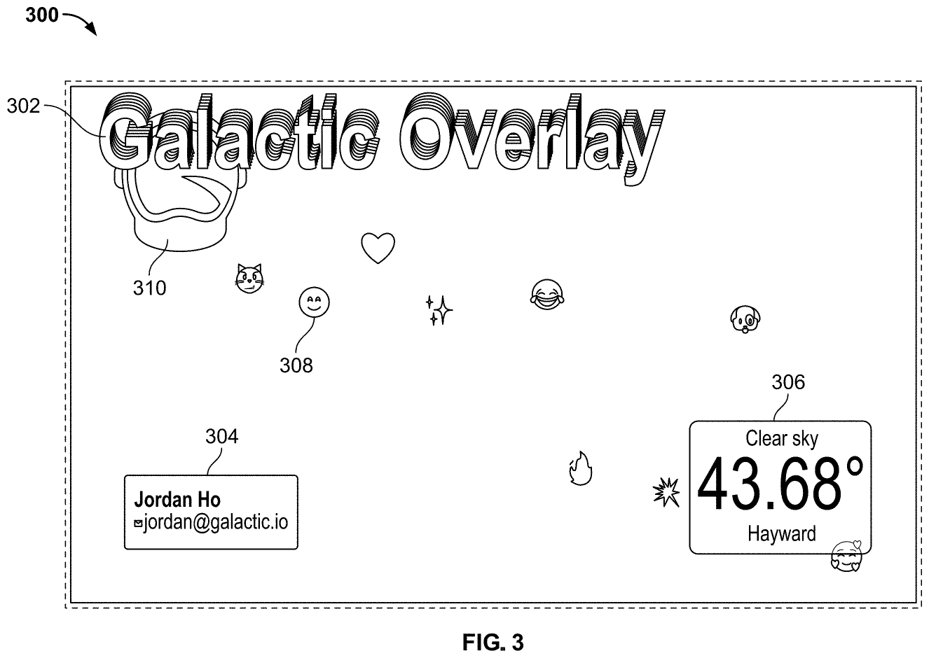

FIG. 3 illustrates one or more overlay effects including a plurality of visual effects, according to some embodiments. Each visual effect, corresponding to one or more overlay effect 300, in some embodiments, can be instantiated by a particular application, or, in some cases, a single application may present more than one visual effect. In some examples, multiple effects can be integrated into the one or more overlay effects 300. As shown in FIG. 3, in one example, the words “Galactic Overlay” 302 are presented in a particularly large font and color scheme, both of which can be selected by a user within a “text overlay” application. In some embodiments, a user identification effect 304 is shown in the lower left of FIG. 3. In some examples, the user identification 304 indicates the user name and/or ID of the individual presenting the video, e.g., as shown in FIG. 3. At the lower right of FIG. 3, a weather effect 306 is shown. In some embodiments, the weather effect 306 can present the current weather at a particular location. In some examples, the weather effect 306 can present the weather at a location of a user, presenter, viewer, and/or some other location configured in the application. In some embodiments, data in the overlay effects 300 that can change, e.g., time, weather, stock tickers, among others, can be updated consistently in real-time and/or, in some cases, at some other frequency as designed into the application that creates the effect. In some embodiments, the one or more overlay effects 300 can include various images. In some examples, and as shown in FIG. 3, the overlay effects 300 can include images such as “emojis” 308, e.g., a heart, a smiling face, a flame, a star, among other emojis. The overlay effects 300, in some embodiments, can be static and/or dynamic. In some examples, a static overlay effect 300 can include an image that remains at the same location on the display. In one example, an image, e.g., an astronaut icon 310, is shown that remains in the same spot on the screen. In some examples, a dynamic overlay effect can include the image appearing moving around the screen and/or being shown at multiple locations of the display. In one example, and as shown in FIG. 3, the dynamic effect can include emoji's 308 raining and/or falling from a top to the bottom of the display and/or overlay. In some embodiments, the settings that control the overlay effects can include settings available to the user within the application used to add these effects (e.g., an “emoji rain” application). In the same example, these settings can include image(s) that are presented and/or the behavior of the images: static versus dynamic, the speed and/or direction the images move, among other settings.

In some embodiments, the participants in a meeting, virtual collaboration meeting and/or call can interact with the overlay effects 300. In some examples, a shopping app can present a QR code to users and/or participants. In some examples, the users and/or participants can use one or more computing devices (e.g., mobile phones) to scan the QR code. In the same implementations, the users and/or participants can be directed to a specific web page to purchase an item only available to those in the meeting, virtual collaboration meeting and/or call. In an alternative example, an app of the video collaboration enhancement platform can allow all meeting participants to play a trivia game. In the same example, the app can synchronize the answers of each participant to display on each participant's device once everyone has answered a question from the game.

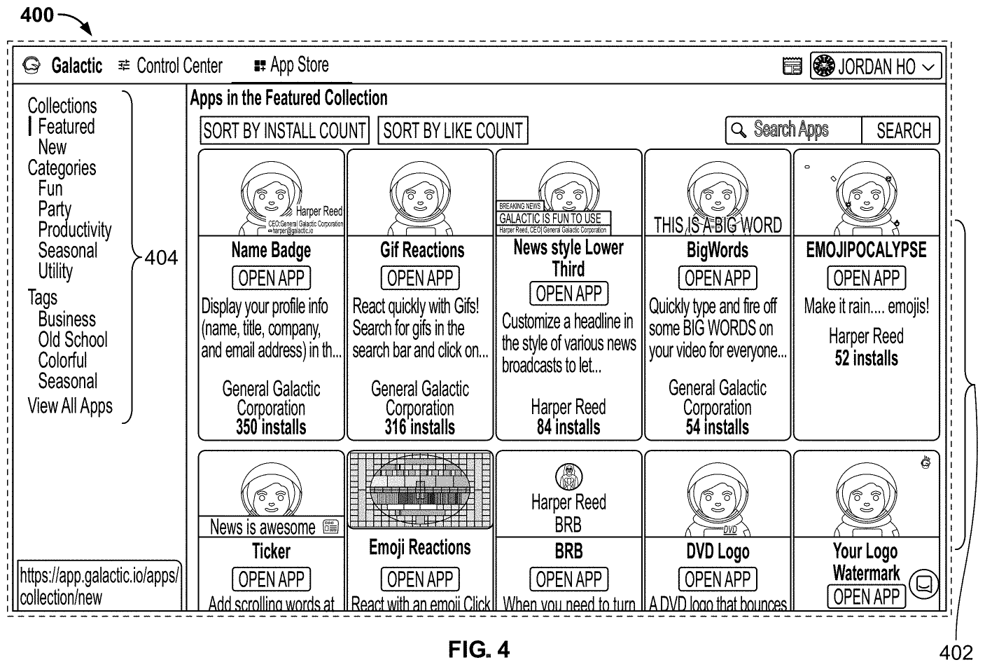

FIG. 4 illustrates an exemplary application store, according to some embodiments. In some embodiments, the application store 400 can be configured to allow a user to search for various applications 402 to add to a user profile corresponding to the user's video collaboration enhancement platform. In some embodiments, the applications 402 can be organized 404 by category, metadata tags, recency, and/or popularity. In some examples, when a user decides which application 402 to include in their profile, the user can select the application 402 and the application code can be installed into their profile. In the same example, subsequent to installing the application code, the application can be displayed such that it can appear as an installed application in a user's control center of the user's video collaboration enhancement platform.

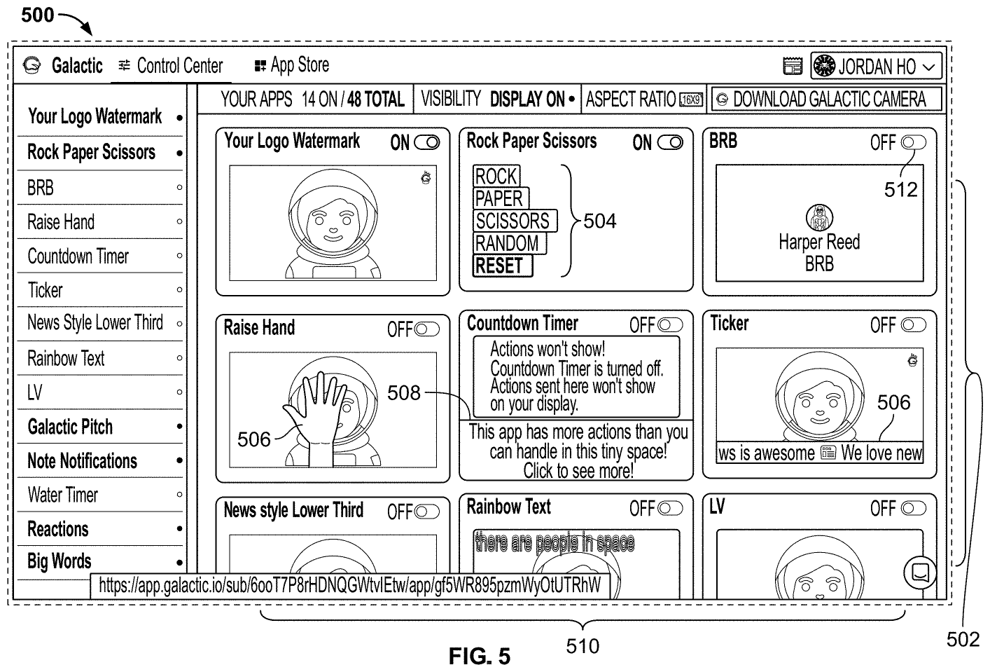

FIG. 5 illustrates an exemplary control center, according to some embodiments. In some embodiments, the control center 500 can be used by a user to configure one or more settings 504 and/or video effects 506 included in their video presentations and/or video collaboration software. In one example, the settings can include options and/or selections related to one or more applications 502. In a particular example, in a rock paper scissors game application, the settings 504 can include each option, e.g., rock, paper scissors and an option to reset those selections. In another example, for the countdown timer, an option 508 showing more settings to the user can be presented, e.g. when the display space is limited and not all the settings can be shown in the provided display size. In some embodiments, the control center 500 can present a tiled selection screen 510 showing one or more applications installed by the user, and a toggle switch 512 allowing the user to turn a particular application (and, as a result, its effect(s)) on or off In some implementations, other settings/configurations available can include an aspect ratio of the effect setting, a color shifting of the effect setting, among other settings.

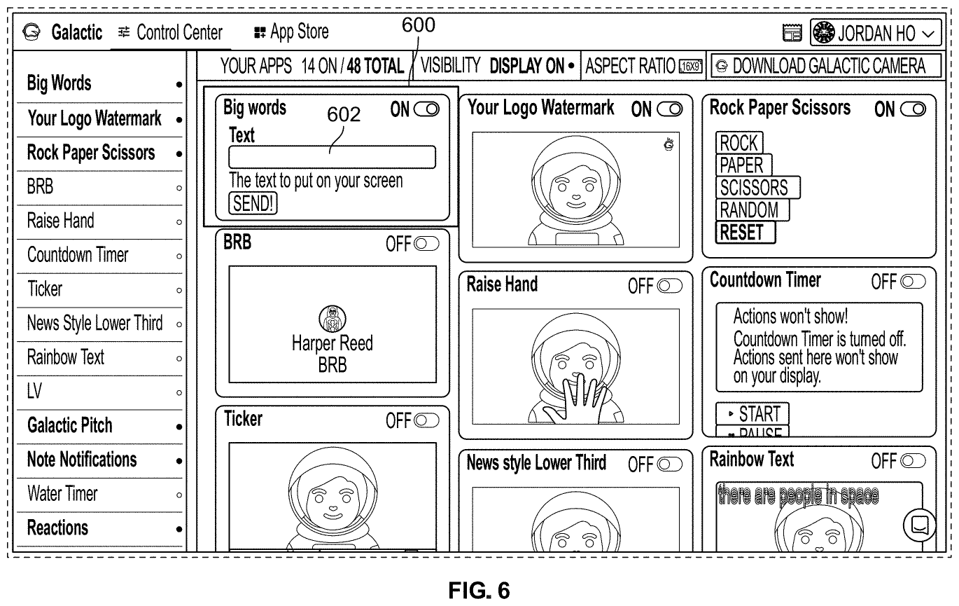

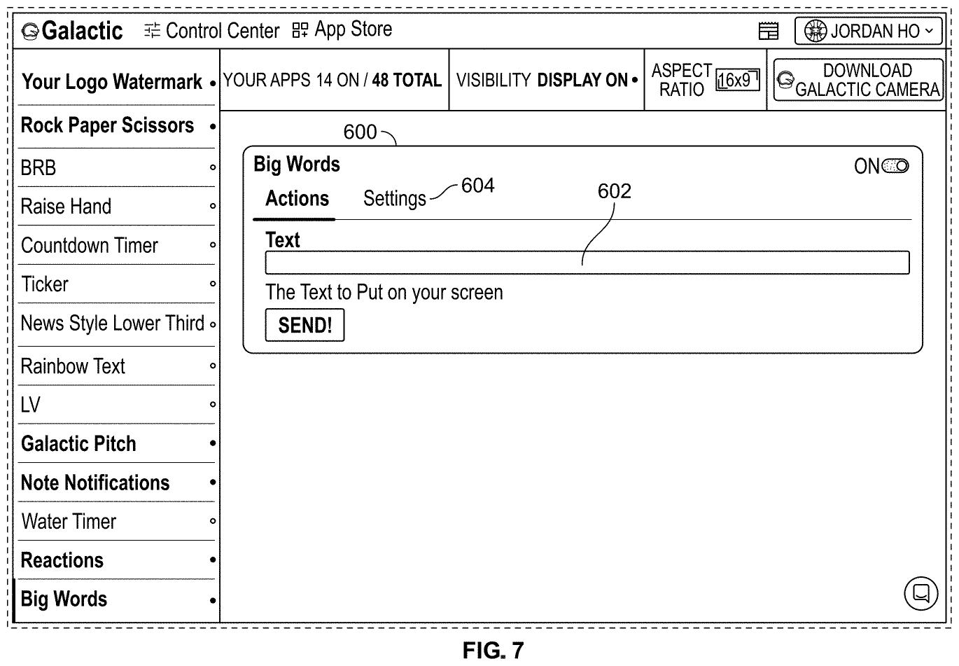

FIGS. 6 and 7 illustrate an application customization, according to some embodiments. In one example, as shown in FIGS. 6 and 7, a “Big Words” application 600 can create an overlay including words in a large font. In some examples, the user can type in specific words in a field 602 that the user may want to appear on the augmented video feed. In some instances, the user can select the font size and one or more font effects, e.g., bold, shadowed, color, among other font characteristics in addition to the text itself. In one example, a settings tab 604 can include instructions for implementing settings, and can provide general information about the application.

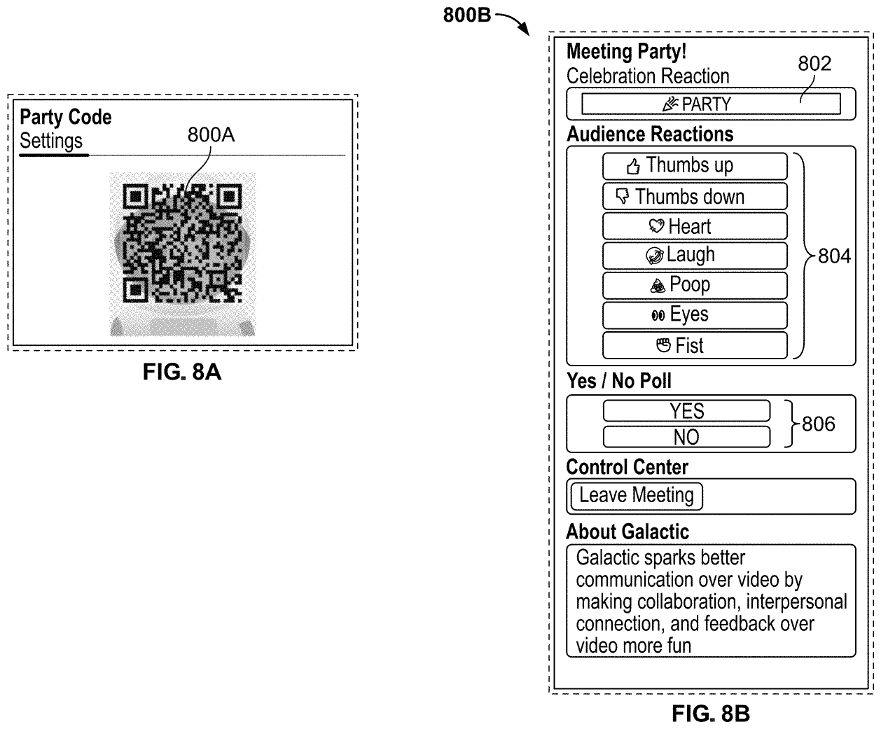

FIG. 8A illustrates a QR code invite for meeting participants, according to some embodiments. In some embodiments, a video collaboration enhancement platform can generate a unique QR code 800A. In some examples, the QR code can be scanned by a meeting/call participant. In some examples, the QR Code can be sent to an invitee and/or user via text message, email and/or other means. In some implementations, upon scanning and/or processing the QR code 800A, the invitee can be connected to the video collaboration enhancement platform to interact with the presenter's display. In some instances, instead of a QR code 800A, the invitee can be presented with a user badge, ticker, or web link, which, when selected, can connect the invitee with a group of participants for a meeting and/or call. In some embodiments, the invitee may not be required to install any applications to join the platform, or take any other action to join the call.

FIG. 8B, illustrates a selection of interactive features for a meeting participant, according to some embodiments. In some embodiments, once an invitee, e.g., now participant, joins a meeting, the participant can be presented with a collection of interactive features 800B that can allow the participant to react 802 to events on the screen. In some examples, the participant can react by selecting from one or more options 804: a button, e.g., thumbs up, clap, etc., party, e.g., throw confetti. In some examples, the participant can react by voting 806, e.g., yes or no. In the same example, the results of the participants actions can appear on the presentation being seen by the other participants.

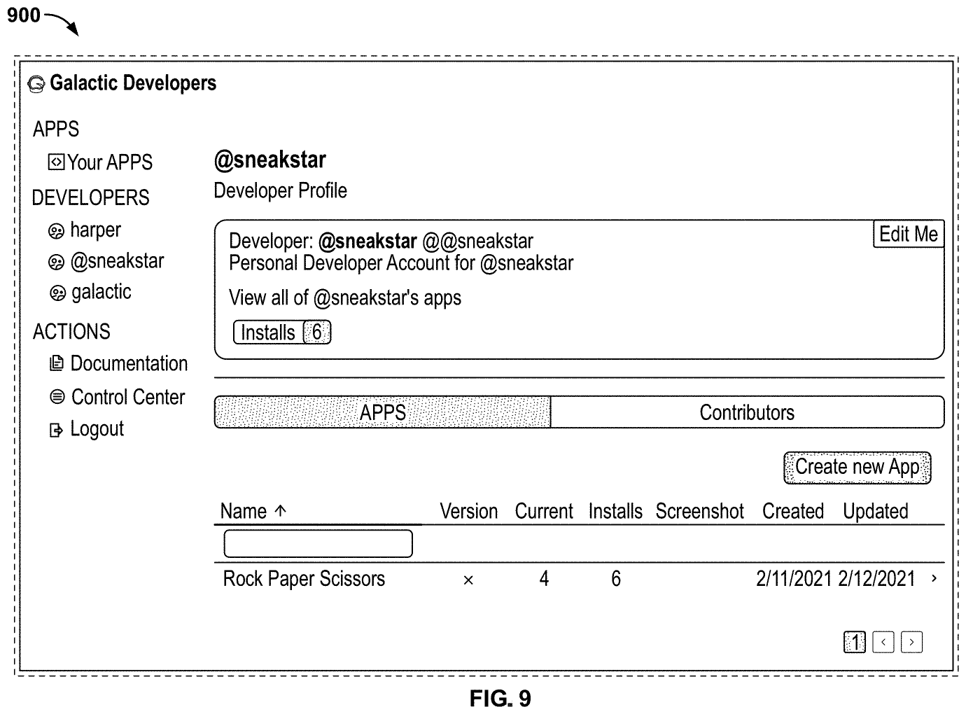

FIG. 9 illustrates a profile page for the developer platform used by developers, according to some embodiments. In some embodiments, the developer can be affiliated with the platform provider and/or a member of the user community. In some embodiments, the developer platform 900 can be used to create, update, preview, version, and/or manage the applications that appear in the application store. In some examples, other application settings around access, like whether or not an app can be publicly available and/or only available to a subset of users which can also be managed by and/or within the developer platform. In some instances, the developer platform can include features that allow certain developers to review and/or approve the work of other developers. In some examples, the platform can maintain a high quality, and/or consistent set of applications for the users.

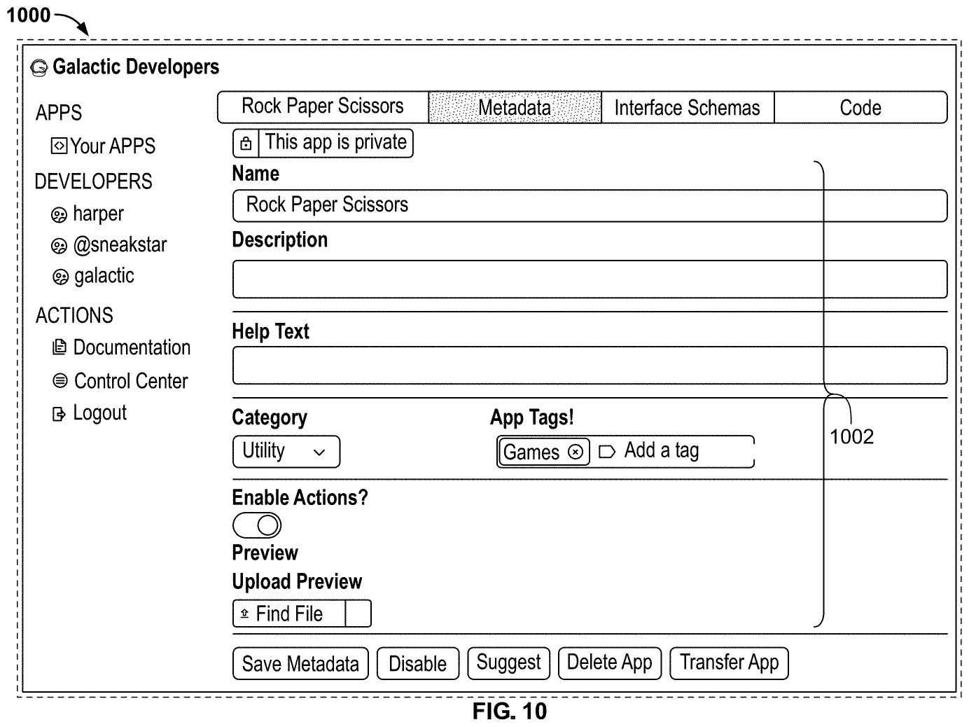

FIG. 10 illustrates an exemplary developer platform, according to some embodiments. In some embodiments, the developer platform 1000 can be configured to allow a user to enter information 1002, configurations and/or other metadata about an application in development.

### Hardware and Software Implementations

In some embodiments, a computer having one or more processors can be adapted to execute computer program modules for providing functionality described herein. In some examples, and as used herein, the term “module” can refer to a computer program logic utilized to provide the specified functionality. Thus, a module, in some embodiments, can be implemented in hardware, firmware, and/or software. In one embodiment, program modules can be stored on a storage device, loaded into the memory, and/or executed by the processor.

In some embodiments, exemplary entities described herein can include other and/or different modules than the ones described here. The functionality attributed to the modules can be, in some embodiments, performed by other or different modules in other embodiments. Moreover, in some examples, this description can occasionally omit the term “module” for purposes of clarity and convenience.

The present invention can also, in some embodiments, relate to one or more apparatus for performing the operations herein. Such an apparatus can be specially constructed for the required purposes, in some examples, or it can include a general-purpose computer selectively activated or reconfigured by a computer program stored on a computer readable medium that can be accessed by the computer. Such a computer program can be, in some implementations, stored in a non-transitory computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of computer-readable storage medium suitable for storing electronic instructions, and each can be coupled to a computer system bus. Furthermore, in some instances, the computers referred to in the specification can include a single processor, and/or can be architectures employing multiple processor designs for increased computing capability.

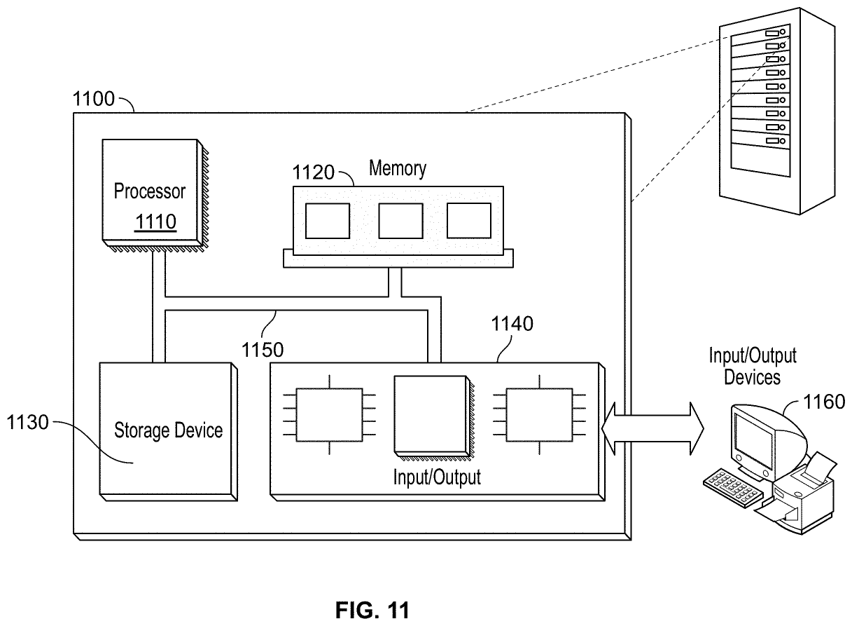

FIG. 11 is a block diagram of an example computer system 1100 that may be used in implementing the technology described in this document. General-purpose computers, network appliances, mobile devices, or other electronic systems may also include at least portions of the system 1100. The system 1100 includes a processor 1110, a memory 1120, a storage device 1130, and an input/output device 1140. Each of the components 1110, 1120, 1130, and 1140 may be interconnected, for example, using a system bus 1150. The processor 1110 is capable of processing instructions for execution within the system 1100. In some implementations, the processor 1110 is a single-threaded processor. In some implementations, the processor 1110 is a multi-threaded processor. The processor 1110 is capable of processing instructions stored in the memory 1120 or on the storage device 1130.

The memory 1120 stores information within the system 1100. In some implementations, the memory 1120 is a non-transitory computer-readable medium. In some implementations, the memory 1120 is a volatile memory unit. In some implementations, the memory 1120 is a non-volatile memory unit.

The storage device 1130 is capable of providing mass storage for the system 1100. In some implementations, the storage device 1130 is a non-transitory computer-readable medium. In various different implementations, the storage device 1130 may include, for example, a hard disk device, an optical disk device, a solid-date drive, a flash drive, or some other large capacity storage device. For example, the storage device may store long-term data (e.g., database data, file system data, etc.). The input/output device 1140 provides input/output operations for the system 1100. In some implementations, the input/output device 1140 may include one or more of a network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer and display devices 1160. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 1130 may be implemented in a distributed way over a network, for example as a server farm or a set of widely distributed servers, or may be implemented in a single computing device.

Although an example processing system has been described in FIG. 11, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; and magneto optical disks. The processor and the memory can be supplemented by, or incorporated in, special purpose logic circuitry.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

### Terminology

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of” “only one of” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

In some embodiments, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A video collaboration enhancement system, comprising:
one or more computer processors programmed to perform operations comprising:
initiating a virtual camera, wherein the virtual camera is configured to output an augmented video feed, the augmented video feed comprising one or more virtual overlay effects;
combining one or more virtual overlay effects with a video feed received from a physical camera to form the augmented video feed, wherein the one or more virtual overlay effects are displayed in conjunction with the video feed received from a physical camera; and
displaying the augmented video feed on a display device.

2. The video collaboration enhancement system of claim 1, wherein the one or more virtual overlay effects comprise a static virtual overlay.

3. The video collaboration enhancement system of claim 1, wherein the one or more virtual overlay effects comprise a dynamic virtual overlay.

4. The video collaboration enhancement system of claim 1, wherein the one or more virtual overlay effects comprise a text overlay application.

5. The video collaboration enhancement system of claim 4, wherein the text overlay application is configured to allow a user to select at least one of a user selected font, a user selected font size, or a user selected font color.

6. The video collaboration enhancement system of claim 1, wherein the one or more virtual overlay effects comprise a user identification application.

7. The video collaboration enhancement system of claim 6, wherein the user identification application is configured to allow a user to select at least one of a user name, or a user identification.

8. The video collaboration enhancement system of claim 1, wherein the one or more virtual overlay effects comprise a weather application.

9. The video collaboration enhancement system of claim 8, wherein the weather application is configured display at least one of weather information at a location of a user, or weather information of a user selected location.

10. The video collaboration enhancement system of claim 1, wherein the one or more virtual overlay effects comprise at least one of data updated in real time, or data updated in a user selected frequency.

11. The video collaboration enhancement system of claim 1, wherein the one or more virtual overlay effects comprises an image.

12. The video collaboration enhancement system of claim 11, wherein the image comprises an emoji.

13. The video collaboration enhancement system of claim 11, wherein the image comprises a QR code.

14. The video collaboration enhancement system of claim 13, wherein the QR code comprises a link to a website with an exclusive purchase offer, a video game, or a collaboration platform.

15. The video collaboration enhancement system of claim 1, wherein the virtual overlay comprises at least one of a time application, a stock application, a shopping application or a game application.

16. A computer-implemented method, comprising:
initiating a virtual camera, wherein the virtual camera is configured to output an augmented video feed, the augmented video feed comprising one or more virtual overlay effects;
combining one or more virtual overlay effects with a video feed received from a physical camera to form the augmented video feed, wherein the one or more virtual overlay effects are displayed in conjunction with the video feed received from a physical camera; and
displaying the augmented video feed on a display device.

17. The computer-implemented method of claim 16, wherein the one or more virtual overlay effects comprises a static virtual overlay.

18. The computer-implemented method of claim 16, wherein the one or more virtual overlay effects comprises a dynamic virtual overlay.

19. The computer-implemented method of claim 16, wherein the one or more virtual overlay effects comprise at least one of a text overlay application, a weather application, time application, a stock application, a shopping application or a game application.

20. A non-transitory computer-readable medium having instructions stored thereon that, when executed by one or more computer processors, cause the one or more computer processors to perform operations comprising:
initiating a virtual camera, wherein the virtual camera is configured to output an augmented video feed, the augmented video feed comprising one or more virtual overlay effects;
combining one or more virtual overlay effects with a video feed received from a physical camera to form the augmented video feed, wherein the one or more virtual overlay effects are displayed in conjunction with the video feed received from a physical camera; and
displaying the augmented video feed on a display device.
